(19) United States
(12) Patent Application Publication
(10) Pub. No.: US 2026/0203656 A1
(43) Pub. Date: Jul. 16, 2026

(54) APPARATUS AND METHOD FOR ENABLING ASYNCHRONOUS FEDERATED LEARNING

(71) Applicant: Lenovo (Singapore) Pte. Limited, Singapore (SG)

(72) Inventors: Dimitrios Karampatsis, Ruislip (GB); Emmanouil Pateromichelakis, Viersen (DE); Konstantinos Samdanis, Munich (DE)

(73) Assignee: Lenovo (Singapore) Pte. Limited, Singapore (SG)

(21) Appl. No.: 19/133,905

(22) PCT Filed: May 3, 2023
(86) PCT No.: PCT/EP2023/061592

§ 371 Date: May 29, 2025

(30) Foreign Application Priority Data
Mar. 30, 2023 (GR) 20230100268

(51) Int. Cl. G06N 20/00

(52) U.S. Cl. CPC G06N 20/00

(57) ABSTRACT

The invention provides a server apparatus, a client apparatus, and a corresponding method for enabling asynchronous federated learning. The method comprises the steps of selecting a subset of a plurality of clients available for federated learning; distributing, to each of the selected clients, parameters of the ML model allowing the client to train the ML model on local data; receiving a local update for the ML model from a client that has completed training of the ML model on local data; generating a globally updated ML model by applying the at least one received local update to the ML model; determining a model accuracy of the globally updated ML model; and iterating at least the steps of distributing, receiving, generating, and determining. A new iteration is started by distributing parameters of the globally updated ML model when at least one of one or more pre-defined iteration conditions is fulfilled, at least one of the one or more pre-defined iteration conditions being independent of whether local updates have been received from all of the selected clients. The FL training process for a ML model is thus speeded up by starting the new iteration when a predefined condition is met even before all local updates have been received from all of the selected clients.

### TECHNICAL FIELD

The present invention relates to network analytics and machine learning in the context of mobile communication, and in particular to a technique for training a machine learning model in accordance with a federated learning scheme.

### BACKGROUND

Network analytics and AI/ML (Artificial Intelligence/Machine Learning) is deployed in the 5G (5th Generation of Mobile Communication) core network by introducing NWDAF (Network Data Analytics Function) that considers the support of various analytics types, e.g., UE (User Equipment) Mobility, User Data Congestion, NF (Network Function) load, and others as elaborated in TS 23.288. Analytics types can be distinguished and selected by a consumer using the Analytics ID. Each NWDAF may support one or more Analytics IDs and may have the role of inference referred to as NWDAF containing AnLF (Analytics Logical Function) (or simply AnLF), or ML model training called NWDAF containing MTLF (Model Training Logical Function) (or simply MTLF) or both. AnLF that support a specific Analytics ID inference subscribes to a corresponding MTLF that is responsible for ML model training.

FIG. 1 is a block diagram providing an overview of the various NWDAF flavours including the potential input data sources and output consumers. Input data sources and output result consumers may include 5G core NFs, AFs (Application Functions), 5G core data repositories, e.g., ADRF (Analytical Data Repository Function), and the OAM (Operations, Administration and Maintenance). Communication with untrusted AFs may be implemented via NEFs (Network Exposure Functions). OAMs may include MnS (Management Service) Consumers or MFs (Management Functions). MTLF and AnLF may exchanges AI/ML models, e.g., in terms of parameters or weights or by the means of serialization or containerization. Optionally, DCCF (Data Collection Coordination Functionality) and MFAF (Messaging Framework Adaptor Function) may be involved to distribute and collect repeated data towards or from various data sources.

The conventional enablers for analytics are based on supervised/unsupervised learning, which may face some major challenges, including user data privacy and security, which may complicate collection of UE level data for NWDAF. Moreover, with the introduction of MTLF, various types of data from different areas are needed for training an ML model for an NWDAF containing MTLF. However, for an NWDAF containing MTLF it may be difficult to collect all the raw data from distributed data sources.

To address these challenges, 3GPP adopted Federated Learning (FL), also known as Federated Machine Learning. The FL technique can be employed in an NWDAF containing MTLF to train an ML model without any transfer of raw data. Instead, only the ML model or the ML model parameters or weights (the ML model is considered to be fully characterized in terms of its ML model parameters or ML model weights, with the latter terms here being used synonymously) are transferred among the MTLFs that support the FL capability. In the context of analytics, there are two FL capabilities defined, namely the FL server and the FL client.

The FL server is responsible for handling the FL process in terms of selecting the FL clients used for training the ML model based on their ML model training latency, aggregating the ML model parameters received from the FL clients in order to generate an updated version of the ML model, determining when the updated ML model conforms to a specified target performance (e.g., based on ML model validation and testing) and/or when a certain confidence level is reached, and distributing the updated ML model among the AnLFs, which subscribed into receiving updates or requested ML model re-training.

The FL client is responsible for performing ML model training once this is requested from the FL server using local data and for sending the ML model parameters to the FL server once the local training is completed.

The FL capabilities related to an FL server and an FL client can be registered to each corresponding MTLF in the NRF (Network Repository Function) with respect to specific Analytics IDs and for specific ML models. The process of ML model training using FL can be performed in a number of repeated iterations. In each iteration, the FL server selects FL clients and provides them with the ML model parameters. Each FL client trains the ML model using local data and returns an updated version of the ML model parameters back to the FL server. The FL server aggregates the received ML model parameters and repeats this process by selecting FL clients and distributing the updated ML model parameters. The ML model training may be completed when a certain target performance or prediction confidence level is reached, which may be determined based on ML model validation and testing performed by the FL server.

In a conventional FL process, the FL Server waits until responses from all FL clients have been received before the received ML model parameters is aggregated and an updated version of the ML model is distributed in the next iteration. Each FL client, however, may have its own schedule to collect data and to perform the training process by using its own computing and communication resources. This means that the FL process will be performed only at the pace of the slowest FL client. Variations in time schedule related to each FL client may challenge the synchronization of the entire FL process and may introduce further delays for training the ML model.

Throughout this specification, the expressions “ML model distribution” and “distribution of ML model parameters” are used synonymously. It is understood that the term “distribution of ML model parameters” is not to be considered as a limitation to a specific technique for distributing the ML model. The skilled person will understand that the ML model may equally be performed by sending the parameters or weights of the ML model, or by sending the ML model via serialization or containerization or by any other means that can communicate ML model information between the FL server and FL clients, all of which are considered to be comprised by the term “distribution of ML model parameters”.

### SUMMARY

It is an object of the invention to overcome the above problems in the conventional FL process, and in particular to provide a server apparatus, a client apparatus, and a method that can accelerate the FL process.

In order to achieve these objectives, it is the particular approach of the present invention to adopt an asynchronous process for Federated Learning, wherein the FL server uses the received local ML model updates to generate a globally updated ML model and to distribute the globally updated ML model even before local updates have been received from all FL clients.

According to a first aspect of the invention, a server apparatus for training a machine learning (ML) model in collaboration with a plurality of clients in accordance with a scheme for federated learning is provided. The server apparatus is configured to perform the steps: selecting a subset of a plurality of clients available for federated learning; distributing, to each of the selected clients, parameters of the ML model allowing the client to train the ML model on local data; receiving a local update for the ML model from a client that has completed training of the ML model on local data; generating a globally updated ML model by applying the received local update to the ML model; and determining a model accuracy of the globally updated ML model. The server apparatus is further configured to iterate at least the steps of distributing, receiving, generating, and determining. A new iteration is started by distributing parameters of the globally updated ML model when at least one of one or more pre-defined iteration conditions is fulfilled, at least one of the one or more pre-defined iteration conditions being independent of whether local updates have been received from all of the selected clients.

Preferably, the server apparatus is further configured to repeat the receiving, generating, and determining steps until an improvement in the model accuracy caused by the lastly received local update does not exceed a predefined threshold, wherein a new iteration is started as soon as the improvement in the model accuracy caused by the lastly received local update exceeds the predefined threshold.

In this manner, the FL process is speeded up because a new iteration is started when local updates from the current iteration fail to provide significant improvements. It is thus no longer necessary to wait for slow clients providing ineffective updates.

Preferably, a new iteration is started whenever a local update has been received from one of the selected clients, said iteration being started by distributing the parameters of the globally updated ML model to the client from which the local update was received.

In this manner, the FL process is further speeded up because a new iteration is started for each client individually as soon as that client has provided its local update.

Preferably, the server apparatus is further configured to complete training of the ML model when a target training time limit is up or when the model accuracy of the globally updated ML model has reached a target value.

In this manner, requirements with regard to duration of the training process and the desired model accuracy can be met.

Preferably, the server apparatus is further configured to generate, in response to receiving a local update for the ML model from a client, rating information indicating a measure of an impact of the local update received from said client on the model accuracy and/or a time required by said client for completing the training of the ML model on the local data; and to store the generated rating information in association with an identifier of said client.

In this manner, rating information which may be useful for selecting the FL clients and/or for assigning optimized training tasks to each of the selected clients, can be collected and saved for future reference.

Preferably, the server apparatus is further configured to obtain, for each of the clients available for federated learning, rating information indicating a measure of an impact of a local update received previously from said client on the model accuracy and/or a time required by said client for completing a previous training of the ML model on local data; and to select the subset of the plurality of clients available for federated learning based at least in part on the obtained rating information.

In this manner, a set of clients can be selected, based on previously collected rating information, that is particularly well suited for a given training task.

Preferably, the server apparatus is further configured to obtain, for each of the plurality of clients available for federated learning, data statistics information indicating at least one of a range, a volume, a mean, and a variability of the local data offered by said client for training the ML model; and to select the subset of the plurality of clients available for federated learning based at least in part on the obtained data statistics information. Preferably, the server apparatus is further configured to obtain, for each of the plurality of clients available for federated learning, data context information indicating a context in which the local data was collected, including at least one of a network condition, a network load condition, a network use case, a radio access technology, a network slice, a service ID, an application ID, and a time when the local data was collected; and to select the subset of the plurality of clients available for federated learning based at least in part on the obtained data context information.

In this manner, a set of clients can be selected, based on data statistics and/or context information of the local training data, that is particularly well suited for a given training task.

Preferably, the server apparatus is further configured to generate, for each of the selected clients, target training data information indicating a subset of the local data to be used for training the ML model; and to provide each of the selected clients with the respective target training data information so that each client trains the ML model on the respective subset of the local data only. Preferably, the local data comprises a plurality of data samples, each data sample comprising a plurality of data features, wherein the target training data information indicates a constraint on the data samples and/or the data features that are to be used for training the ML model.

In this manner, the model training process can be split into smaller tasks, each task being focused on a subset and/or subrange of the local training data.

Preferably, the server apparatus is further configured to obtain, for each of the selected clients, rating information indicating a measure of an impact of a local update received previously from said client on the model accuracy and/or a time required by said client for completing a previous training of the ML model on local data; and to generate the target training data information based at least in part on the obtained rating information.

In this manner, the training tasks assigned to the individual clients can be designed specifically to capabilities of the respective client.

Preferably, the server apparatus is further configured, if the received local updates include a stale update from a client that has performed training of the ML model based on outdated parameters of the ML model of a previous iteration, to apply a weight to the stale update so as to reduce an impact of the stale update on the ML model. Preferably, the server apparatus is further configured to compute the weight for the stale update based on a correlation between the respective impact on the ML model of the stale update and a non-stale update, the non-stale update being a local update received from a client that has performed training of the ML model based on up-to-date parameters of the ML model distributed during the current iteration.

In this manner, the impact of non-stale updates, which may be more relevant for updating the current ML model, can be boosted over the impact of stale updates, which may be less relevant.

Preferably, the server apparatus is further configured to exclude a stale update from generating the globally updated ML model if a predetermined condition is met, said predetermined condition including at least one of an amount of time that has lapsed, or a number of iterations that have been completed, since the outdated parameters were distributed, a number of non-stale updates received within the current iteration, the non-stale update being a local update received from a client that has performed training of the ML model based on up-to-date parameters of the ML model distributed during the current iteration, an impact of the stale update on a performance of the globally updated ML model, and rating information on the client from which the stale update has been received.

In this manner, stale updates that are exceedingly old and may thus be expected to have no relevance to the present version of the ML model can be discarded, thus avoiding a deterioration of the model accuracy by applying inappropriate updates.

Preferably, the server apparatus is further configured to send, prior to starting a new iteration or completing training of the ML model, an early termination request to the selected clients from which a local update has not yet been received, requesting said clients to stop the training of the ML model and to send a provisional update based on presently available training results; to receive a provisional update sent by a client in response to the early termination request; and to apply the received provisional update to the ML model.

According to a second aspect of the invention, a client apparatus for training a ML model on local data in a federated learning scheme is provided. The client apparatus is configured to: obtain, from a server, parameters of the ML model and target training data information indicating a subset of the local data to be used for training the ML model; perform a training process for the ML model based on the subset of the local data indicated by the obtained target training data information; generate, based on a result of the training process, a local update for the ML model; and send the local update to the server.

Preferably, the local data comprises a plurality of data samples, each data sample comprising a plurality of data features, and the target training data information indicates a constraint on the data samples and/or the data features that are to be used in the training process.

In this manner, the ML model training process can be split into smaller tasks, each task being focused on a subset and/or subrange of the local training data.

Preferably, the client apparatus is further configured to receive, from the server, an early termination request; and in response to receiving the early termination request, to stop the training process for the ML model, to generate a provisional update for the ML model based on presently available training results, and to send the provisional update to the server.

In this manner, training results of slow clients may still be used for updating the ML model, even if the local training process was not completed in time.

Preferably, the client apparatus is further configured to send the local update to the server together with information indicating a version of the ML model on which the training process was performed.

In this manner, the server can determine whether a received local update is a stale update and/or to what degree the update is already outdated and decide how/whether to apply this update to the ML model.

According to a third aspect of the invention, a method for training a ML model in collaboration with a plurality of clients in accordance with a scheme for federated learning is provided. The method comprises the steps selecting a subset of a plurality of clients available for federated learning; distributing, to each of the selected clients, parameters of the ML model allowing the client to train the ML model on local data; receiving a local update for the ML model from a client that has completed training of the ML model on local data; generating a globally updated ML model by applying the at least one received local update to the ML model; determining a model accuracy of the globally updated ML model; and iterating at least the steps of distributing, receiving, generating, and determining. A new iteration is started by distributing parameters of the globally updated ML model when at least one of one or more pre-defined iteration conditions is fulfilled, at least one of the one or more pre-defined iteration conditions being independent of whether local updates have been received from all of the selected clients.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Embodiments and aspects of the invention will be described in the following description and together with the accompanying drawings, wherein

FIG. 1 is a block diagram providing an overview of various NWDAF flavours including the potential input data sources and output consumers.

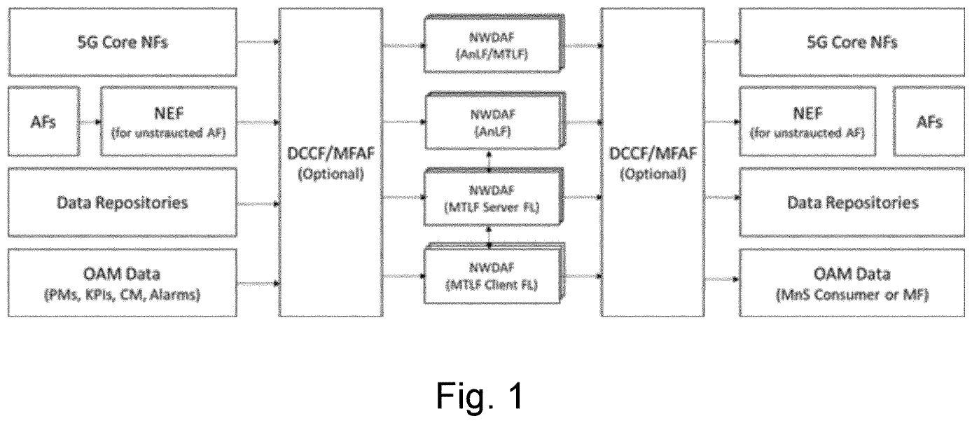

FIG. 2 is a schematic drawing illustrating an example of dividing training data for machine learning into vertical and horizontal data sets.

FIG. 3 is a schematic drawing illustrating a process for asynchronous FL model training according to a first embodiment of the present invention.

FIG. 4 is a schematic drawing illustrating a process for asynchronous FL model training according to a second embodiment of the present invention.

### DETAILED DESCRIPTION

Reference will now be made in detail to the exemplary embodiments, examples of which are illustrated in the accompanying drawings.

The present invention resolves the performance versus latency issues in conventional ML model training by providing an asynchronous process for Federated Learning. The invention further provides mechanisms for selecting appropriate FL clients in each iteration, for speeding up each iteration of the FL model training process, and for dealing with stale information, i.e., local updates derived by slow FL clients for an old version of the ML model that have been received by the FL server only after a new iteration was started and an updated version of the ML model was distributed to newly selected FL clients.

### Mechanisms for Selecting Appropriate FL Clients

The selection of the appropriate FL clients requires the FL server to initially discover the potential FL clients. This process is described in TR 23.700-81, where a FL server registers its FL capability, i.e., FL server or FL client, in NRF. From an NRF inquiry the FL server can discover NWDAFs with FL client capability, a geographical area related to an FL client (locality), and the FL client load which is prone to dynamic changes. From the list of FL client received from the NRF, the FL server may inquire individual FL clients about the data available for FL training, i.e., if they have already collected data that can be used for FL training, and about the time available for performing the FL training.

The selection of the FL clients may be performed based at least in part on statistical properties of the local data that each FL client can offer for training the ML model, such as range, volume, mean, variability, etc., of the local data. Said statistics on the locally available training data may be made available to FL server when the FL server inquires individual FL clients for further information in the preparation phase.

Specifically, the FL server may correlate the data statistics related to each potential FL client to select FL clients with more diverse training data. This may also save network and FL client computing resources.

In addition, the selection of the FL client may also be performed based at least in part on the context of the respective local training data, in particular on the context in which the local training data was collected. This includes, but is not limited to, information indicating network conditions such as network load conditions, use cases that the network was under when data was collected (e.g., energy saving), the specific RAT (Radio Access Technology, e.g., 5G, LTE, WiFi, etc.), the network slice (i.e., S-NSSAI (Single-Network Slice Selection Assistance Information)), a service and/or application ID, time when data was collected (e.g., in the morning, the evening, etc.) or freshness of data.

### Mechanisms for Speeding up Each Iteration

The invention speeds up the FL model training process by allowing an immediate update of the global ML model once the FL server has received an update from an FL client. Moreover, the FL server may start a new FL iteration by distributing the updated global ML model to a set of the newly selected FL clients before all updates have been received from the selected FL client, namely when at least one of one or more pre-defined iteration conditions is fulfilled, at least one of the one or more pre-defined iteration conditions being independent of whether local updates have been received from all of the selected clients. These iteration conditions may include a time limit or a number of the received updates.

Further, the FL model training process may be split into separate tasks so that the FL clients are assigned smaller, but more diverse and targeted tasks for ML model training. FL clients that are expected to be slow due to, e.g., computing resource shortage or high load, may thus be assigned smaller training tasks by indicating a desired horizontal data range or a vertical feature set that the training shall focus on

[symbol]

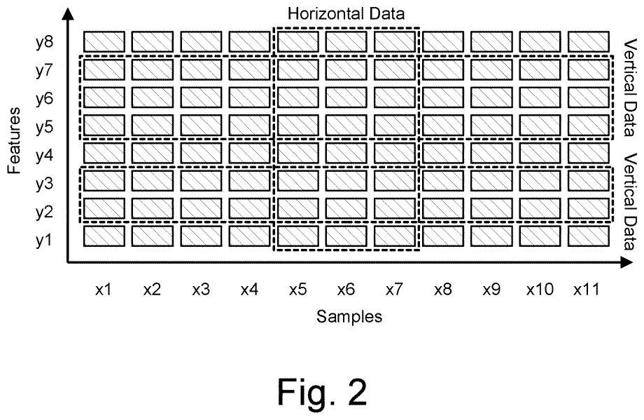

Data statistics, for instance, may be used to divide the desired data space for FL model training into horizontal data sets by splitting the training data based on a specified sample range, which covers all desired ML model features. Features are independent variables in ML models. For example, mobility analytics ML models may include the type of UE (e.g., car), UE speed, and direction as well as a specific granularity of location (e.g., below cell level) as features to predict mobility. Depending on the values of these features, a UE may be predicted, for instance, to handover to a different cell or at a specific location. Vertical data sets can also be arranged considering the features included in specific FL clients over the entire range of data samples. An example of dividing training data for machine learning into vertical and horizontal data sets is illustrated in FIG. 2.

Dividing the FL training process by assigning to FL clients training jobs targeting specified horizontal and/or vertical data can speed up the FL process without compromising the performance. Other data statistics including data volume, mean, and variability can also indicate the plurality and distribution of data in the target data space.

The invention further speeds up the FL model training process by allowing the FL server to send a “last-call message” to slow FL clients before distributing the new ML model version. Slow FL client may then stop and/or abandon the training process and send the current ML model information updates to the FL server.

The FL server may also send a new ML model version to slow FL clients, which upon receiving the new ML model version need to respond with the current ML model information and then start the training process from the beginning or continue the training using the new ML model version.

### Mechanisms for Dealing With Stale Information

The invention also provides mechanisms for dealing with stale update information, i.e., local updates derived by slow FL clients for an old version of the ML model that have been received by the FL server only after a new iteration was started and an updated version of the ML model was distributed to newly selected FL clients.

The FL server may, for instance, impose a weight that controls, i.e., downgrades or attenuates, the impact of stale ML model updates. Stale updates with the weight applied may then still be used for performing the global FL model update. The weights may be computed or derived by correlating the impact of accurate information (i.e., FL client information that uses an up-to-data version of the ML model) and stale information (i.e., of FL client that use a non-up-to-data version of the ML model) on the global ML model update.

The FL server may also introduce a limit for accepting stale ML model updates. This limit may be defined in terms of time or period of iterations after the FL server has performed the global FL model update. The limit may also be formulated in terms of the number of new updates that have already been received from FL clients that use the updated ML model version that is distributed from the FL server.

The FL server may also determine the impact of stale information on the global ML model performance and use this impact as a basis for accepting or rejecting the stale update. The impact of a specific update on the ML model may be determined by the FL server through a ML model validation and testing procedure. The ML model validation and testing procedure may be performed upon receiving a stale update, i.e., an update that was produced using a non-up-to-date version of the ML model. FL client model updates that decrease the global ML model performance may be rejected. Upon receiving a certain number of these non-useful updates, the FL server may reject all further stale updates.

The FL server may also generate rating information of the FL clients. Rating information may indicate performance, speed, or reliability of the client executing the local training process. Rating information may also indicate accuracy, usefulness or impact of the updates generate by the respective FL client. Rating information may be stored locally in the FL server for the duration of the FL process, so that it can use it for each different iteration. Rating information may also be generated after each FL process and stored by the NRF to influence the priority in the NF profile described in TS 29.510 that may impact the selection of FL clients for future FL processes.

### First Embodiment

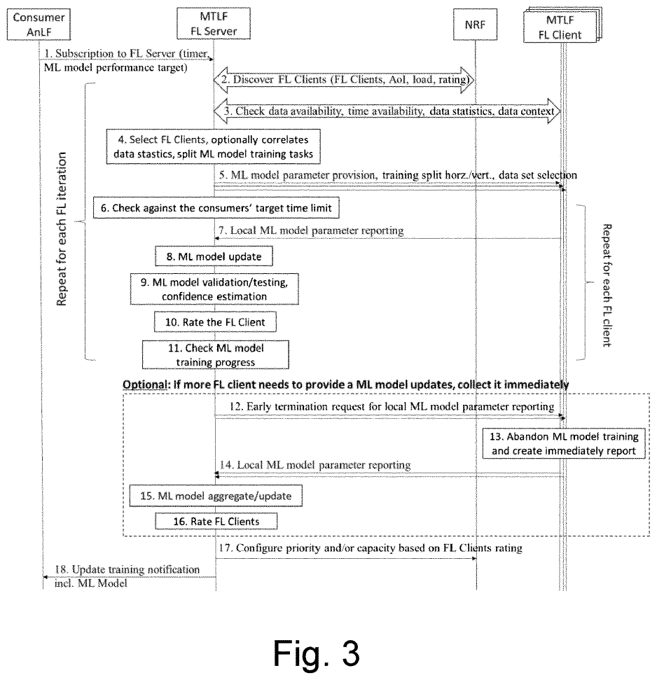

FIG. 3 is a schematic drawing illustrating a process for asynchronous FL model training according to a first embodiment of the present invention. This process will be explained below on the assumption that FL capabilities, i.e., FL server and FL client, related to a specific NWDAF containing MTLF are already registered in the NRF.

The process starts in step 1, in which the consumer, i.e., an NWDAF containing AnLF, issues a ML model subscription request to the FL server. This request may include the Analytic ID and ML model filter information, as described in TS 23.288. The request may also include an indication of a desired time when the ML model training update shall be performed or completed and/or a ML model performance target value.

In subsequent steps 2-4, the FL server selects a set of FL clients that will be used during the next iteration of the FL model training process.

Specifically, in step 2, the FL server sends a request to an NRF to discover potential FL clients in an Area of Interest (AoI). The NRF provides information on FL clients. Said information may include the load of each FL client. The information provided by the NRF may also include rating information and/or priority information obtained from a previous use of the respective FL client during FL model training, such as a measure of an impact of the local update received from said client on an accuracy of the ML model and/or a time required by said client for completing the training of the ML model on the local data.

Once a list of potential FL clients is received, the FL server checks in step 3 whether the potential FL client has collected already the data required for local training (data availability of the potential FL client). The FL server further checks whether the potential FL client has the computational resources required for completing the local training process in time or has no other highly important tasks scheduled (time availability of the potential FL client). In addition, the FL server may check data statistics information indicating statistical properties of the locally collected training data and data context information indicating conditions under which the local training data was collected.

In step 4, the FL server analyses the responses and then selects the FL clients that shall participate in the next FL iteration.

At this stage, the FL server may optionally split the ML model training into smaller tasks, e.g., by requesting at least some of the FL clients to perform ML model training only for a limited set of the local training data and/or a for a limited range of model features, as described above. In this manner, the FL server can still select FL clients that have only a limited amount of computational resources available, i.e., FL clients that are expected to exhibit a subpar time duration for performing local training, but have valuable data for training the ML model.

In step 5, the FL server sends a request to each of the selected FL clients that shall participate in the next FL iteration to perform the ML model training using their local data. This request may optionally include target training data information indicating a subset of the local data to be used for training the ML model. In this manner, the ML model training may be split into smaller tasks, as described above.

In step 6, the FL server checks the remaining time with respect to the ML model training target time imposed be the consumer (i.e., AnLF). If there is still time left, the FL server waits for at least one of the FL clients to provide a ML model update report (step 7). This report includes an indication of the results of the ML model training process performed by the respective FL client on its local data. The results may be provided in form of a new set of ML model parameters, a set of gradients of ML model parameters (weights), or in any other suitable form.

The results received from the FL client are used by the FL server to update the ML model in step 8. The step of updating the ML model may thus be performed at the FL server in response to receiving an ML model update report from a single FL client and without waiting until all FL clients have sent their ML model update reports.

The thus updated ML model is then validated and/or tested by the FL server in step 9 in order to assess ML model performance, in particular to estimate the expected confidence degree.

In step 10, the FL server may rate the FL client from which it received the local ML model training report. Said rating may indicate a measure of an impact of the local update received from this particular client on an accuracy, performance, or confidence degree of the ML model and/or a time required by said client for completing the training of the ML model on the local data. The FL server may keep the rating information locally at this occasion for further use within the current FL iteration.

In step 11, the FL server checks the ML model training progress. If the ML model performance has not reached a target performance provided by the consumer (i.e., AnLF), then the FL server checks the number of reports received from FL clients. If the FL server has received the reports from all FL clients selected in step 4, then the FL server starts a new iteration by jumping to step 2. If the FL server has not received the reports from all of the selected FL clients, then it checks the ML model improvement considering the last FL client update received. If the last update had a significant impact on the ML model, e.g. the increase in model performance caused by the last update exceeds a certain threshold value, then the FL server waits to receive more FL client report updates and repeats steps 6-11. Otherwise (the last update had only an insignificant impact on the ML model), the FL server abandons the current FL iteration and starts a new iteration by distributing the updated ML model to a newly selected set of FL clients, i.e., by jumping to one of steps 2, 3 or 4.

On the other hand, if the FL server has determined in step 6 that there is no time left with respect to the ML model training target time imposed be the consumer AnLF, or if the FL server has determined in step 11 that the ML model performance has reached the target performance, then the FL server abandons the FL iteration loop. However, before final results of the FL training process are provided to the consumer AnLF, optional steps 12-16 may be performed in order to take into account also provisional results from FL clients that have not yet completed their local ML training process, e.g., FL clients that have not used their entire set of local data for ML model training. To this end, the FL server may send in step 12 an early termination request to all FL clients that have not yet provided an ML model update report. The early termination request may prompt the FL clients to abandon their ML training process and to report back immediately the current ML model updates (step 13). In step 14, the FL server receives the provisional update reports created by FL clients in response to the early termination request. In step 15, the FL server aggregates all the received update reports and updates the global ML model accordingly.

In step 16, the FL server may rate the FL client from which it received the local ML model training reporting. Here, the processing may be similar to that described above in connection with step 8. The thus obtained rating information, however, may be used by the FL server in step 17 for configuring, for each FL client involved in the FL process, the NF profile variables related to the priority and/or capacity parameters to reflect the rating in the NRF.

Finally, in step 18, the FL server provides an update training notification to the consumer (i.e., AnLF), including the updated version of the ML model.

### Second Embodiment

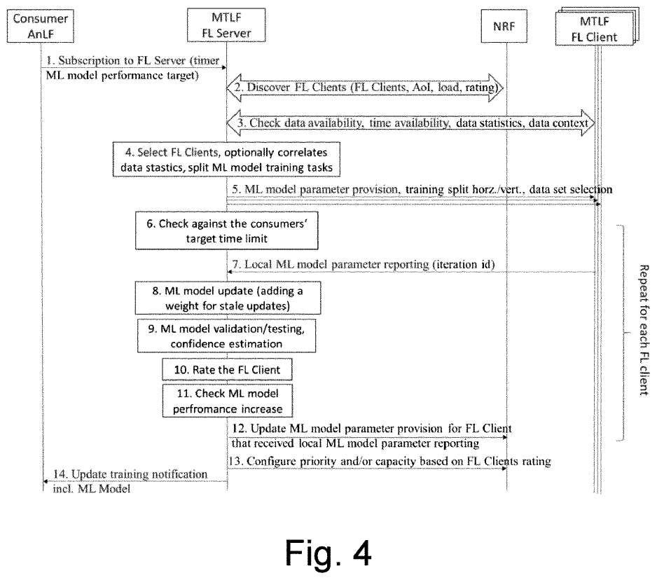

FIG. 4 is a schematic drawing illustrating a process for asynchronous FL model training according to a second embodiment of the present invention. The second embodiment is similar to the first embodiment except that stale update information is also taken into account. The second embodiment will be described under the pre-condition that that FL capabilities, i.e., FL server and FL client, related to specific NWDAF containing MTLF are already registered in the NRF.

The process starts with the selection of a subset of FL clients and the distribution of ML model parameters in steps 1-5, which are identical to steps 1-5 of the process according to the first embodiment described above.

In step 6, the FL server checks the remaining time with respect to the ML model training target time imposed be the consumer (i.e., AnLF). If there is still time left, the FL server waits for at least one of the FL clients to provide a ML model update report (step 7). This report includes an indication of the results of the ML model training process performed by the respective FL client on its local data. The results may be provided in form of a new set of ML model parameters, a set of gradients of ML model parameters (weights), or in any other suitable form.

In contrast to the first embodiment, the ML model update report received in step 7 also includes information indicating a version of the ML model on which the ML model training process was performed. This information may be provided, for instance, in form of an iteration ID or any other suitable identifier. The FL server may then use this information to discriminate stale updates from non-stale updates. The FL server may also distinguish between different stale updates on the basis of their respective age or iteration to which they belong.

In step 8, the FL server updates the ML model based on the ML model update report received from a single FL client, i.e., without waiting for all FL client to respond.

When updating the ML model on the basis of the received ML model update report, the FL server also takes the ML model version information or the iteration ID included in the received ML model update report into account. Specifically, the FL server may apply a weight to the update information in order to reduce the impact of stale updates in the globally update ML model. The FL server may also discard stale updates that are considered to be too old based on, for instance, a difference between the model version or iteration indicated in the model update report and the current model version or iteration.

For instance, if the iteration ID in the received ML model update report indicates that a non-up-to-date ML model was used by the FL client, then the FL server applies a weight to adjust the impact of stale information. Otherwise, the FL server uses the ML model update report directly, i.e., without applying a weight.

The FL server may determine the weight empirically or by correlating the reports received from FL clients with updated ML models with FL clients with non-up-to-date ML models and/or keeping statistics from prior ML model reports and validation/testing results.

The thus updated ML model is then validated and/or tested by the FL server in step 9 in order to assess ML model performance, in particular to estimate the expected confidence degree.

In step 10, the FL server may rate the FL client from which it received the local ML model training report. Said rating may indicate a measure of an impact of the local update received from this particular client on an accuracy, performance, or confidence degree of the ML model and/or a time required by said client for completing the training of the ML model on the local data. The FL server may keep the rating information locally at this occasion for further use within the current FL iteration.

In step 11, the FL server checks the ML model training progress, and in particular whether the ML model performance has reached a target performance provided by the consumer (i.e., AnLF).

If it is determined that the ML model performance has not reached the target performance, then the FL server proceeds with step 12, wherein the FL server provides the updated ML model parameters to the FL client that sent the ML model update report used for updating the ML model in step 8, i.e., the ML model update report received in step 7. After that, a new iteration is started by jumping to step 6, i.e., the FL process is repeated from step 6.

On the other hand, if it is determined that the ML model performance has reached the target performance, then the repeat loop is abandoned and the FL server proceeds with step 13, in which the FL server uses the rating information obtained in step 10 for configuring, for each FL client involved in the FL process, the NF profile variables related to the priority and/or capacity parameters to reflect the rating in the NRF.

Finally, in step 14, the FL server provides an update training notification to the consumer (i.e., AnLF), including the updated version of the ML model.

The above embodiments are described by way of example only. Combinations and variations are possible within the scope of the appended claims. For instance, the aspect of sending an early termination request to slow FL clients to prompt them to send provisional updates before providing the update notification to the consumer (steps 12-15 of the process illustrated in FIG. 3), may also be applied to the second embodiment described in connection with FIG. 4. Further, the aspect of taking stale updates into account (or discarding updates considered to be too stale) by providing each ML model update report with information indicating the version or iteration for which the respective update was derived, and controlling the impact of each update on the global ML model on the basis of whether the respective update is stale (steps 7-8 of the process illustrated in FIG. 4) may also be applied to the first embodiment described in connection with FIG. 3.

The above described features may be implemented as a computer-implemented method in a mobile telecommunications network. All the above described network functions may be computer functions that run either on a standalone computer server that implements the corresponding functions or different network functions may share one or more computer servers. The computer server comprise respective computer hardware, such as at least one processor, at least one memory for saving computer-readable instructions that may be executed by the processor. The computer server may additionally comprise components for communicating with other computers or network devices, such as a network interface card.

What is claimed is:

1-20. (canceled)

21. An apparatus, comprising:
at least one memory; and
at least one processor coupled with the at least one memory and operable to cause the apparatus to:
select a subset of a plurality of clients available for federated learning associated with training a machine learning (ML) model;
distribute, to each of the selected clients, parameters of the ML model associated with training the ML model on local data;
receive a local update for the ML model from a client that has trained the ML model on local data;
generate a globally updated ML model by applying the received local update to the ML model; and
determine a model accuracy of the globally updated ML model.

22. The apparatus of claim 21, wherein the at least one processor is operable to cause the apparatus to:
distribute parameters of the globally updated ML model when one or more pre-defined iteration conditions are fulfilled.

23. The apparatus of claim 22, wherein at least one of the one or more pre-defined iteration conditions is independent of whether local updates have been received from each of the selected clients.

24. The apparatus of claim 21, wherein the at least one processor is operable to cause the apparatus to:
complete training of the ML model when one or more of a target training time limit is up or when the model accuracy of the globally updated ML model has reached a target value.

25. The apparatus of claim 21, wherein the at least one processor is operable to cause the apparatus to:
obtain, for each of the plurality of clients available for federated learning, data statistics information indicating at least one of a range, a volume, a mean, or a variability of the local data offered by said client for training the ML model.

26. The apparatus of claim 25, wherein the at least one processor is operable to cause the apparatus to:
select the subset of the plurality of clients available for federated learning based at least in part on the obtained data statistics information.

27. The apparatus of claim 21, wherein the at least one processor is operable to cause the apparatus to:
send, prior to starting a new iteration or completing training of the ML model, an early termination request to the selected clients from which a local update has not been received, wherein the early termination request comprises an indication to stop the training of the ML model and to send a provisional update based on presently available training results.

28. The apparatus of claim 27, wherein the at least one processor is operable to cause the apparatus to:
receive a provisional update sent by a client in response to the early termination request; and
apply the received provisional update to the ML model.

29. The apparatus of claim 21, wherein the apparatus comprises a mobile communications server apparatus.

30. A method performed by an apparatus, the method comprising:
selecting a subset of a plurality of clients available for federated learning associated with training a machine learning (ML) model;
distributing, to each of the selected clients, parameters of the ML model associated with training the ML model on local data;
receiving a local update for the ML model from a client that has trained the ML model on local data;
generating a globally updated ML model by applying the received local update to the ML model; and
determining a model accuracy of the globally updated ML model.

31. The method of claim 30, further comprising:
distributing parameters of the globally updated ML model when one or more pre-defined iteration conditions are fulfilled.

32. The method of claim 31, wherein at least one of the one or more pre-defined iteration conditions is independent of whether local updates have been received from each of the selected clients.

33. The method of claim 30, further comprising:
completing training of the ML model when one or more of a target training time limit is up or when the model accuracy of the globally updated ML model has reached a target value.

34. The method of claim 30, further comprising:
obtaining, for each of the plurality of clients available for federated learning, data statistics information indicating at least one of a range, a volume, a mean, or a variability of the local data offered by said client for training the ML model.

35. The method of claim 34, further comprising:
selecting the subset of the plurality of clients available for federated learning based at least in part on the obtained data statistics information.

36. The method of claim 30, further comprising:
sending, prior to starting a new iteration or completing training of the ML model, an early termination request to the selected clients from which a local update has not been received, wherein the early termination request comprises an indication to stop the training of the ML model and to send a provisional update based on presently available training results.

37. The method of claim 36, further comprising:
receiving a provisional update sent by a client in response to the early termination request; and
applying the received provisional update to the ML model.

38. The method of claim 30, wherein the apparatus comprises a mobile communications server apparatus.

39. An apparatus, comprising:
at least one memory; and
at least one processor coupled with the at least one memory and operable to cause the apparatus to:
obtain, from a server, parameters of a machine learning (ML) model and target training data information indicating a subset of local data to be used for training the ML model;
perform a training process for the ML model based on the subset of the local data indicated by the obtained target training data information;
generate, based on a result of the training process, a local update for the ML model; and
send the local update to the server.

40. A method, comprising:
obtaining, from a server, parameters of a machine learning (ML) model and target training data information indicating a subset of local data to be used for training the ML model;
performing a training process for the ML model based on the subset of the local data indicated by the obtained target training data information;
generating, based on a result of the training process, a local update for the ML model; and
sending the local update to the server.
